(19) United States
(12) Patent Application Publication
(10) Pub. No.: US 2006/0221891 A1
(43) Pub. Date: Oct. 5, 2006

(54) Information distribution with improved reliability and efficiency for mobile ad hoc networks

(75) Inventors: Ralf Schmitz, Heidelberg (DE); Andreas Festag, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/375,065

(22) Filed: Mar. 15, 2006

(30) Foreign Application Priority Data
Mar. 29, 2005 (DE) 10 2005 014 695.3

(51) Int. Cl. H04Q 7/00; H04L 12/56; H04Q 7/24

(52) U.S. Cl. 370/328; 370/338; 370/390

(57) ABSTRACT

Information is distributed to nodes of a mobile ad hoc network, wherein the nodes dispose of position sensing elements, wherein a predeterminable geographic target area is defined and every information is assigned a pre-determinable lifetime, and wherein an information is distributed during its lifetime to all of the nodes being positioned within the target area and to nodes entering the target area by adding a list of correspondingly neighbored nodes in the target area to the broadcast message by which a node sends the information, and wherein nodes, which receive the message, only re-transmit the message if they have further neighboring nodes in the target area that are not contained in the received list.

### BACKGROUND OF THE INVENTION

1. Field of the Invention

The present invention relates in general to a method for distributing information to nodes of a mobile ad hoc network.

2. Description of the Related Art

Ad hoc networks, in particular mobile ad hoc networks, have been widely come into use during the last years and are now used in very different areas. Ad hoc networks are specific, dynamic self-organizing networks that do not need a pre-figured fixed infra-structure. Such kinds of networks comprise autonomous, mobile nodes that act simultaneously as end systems—for example laptop, palmtop, mobile phone etc.—and as routers and that co-operate in order to exchange information.

Just to give an example, vehicular ad hoc networks (Vehicular Ad hoc Networks, VANETs) should be mentioned. VANETs form specific, highly mobile, self-organizing networks for the vehicle-to-vehicle communication and the vehicle-to-roadside communication, wherein vehicle-to-roadside communication means communication of a vehicle with stationary devices at the roadside (such as, for example, gas stations). The main objective of these networks is to increase road safety by enabling active safety applications, such as, for example, hazard warning or extended brake light. These applications can increase the driver's horizon by informing the road-user concerned as early as possible about potential dangers.

Typically, a specific piece of information (for example, temperature or icy road) which is sensed and processed by a node of an ad hoc network is bound to a geographic area and a specific lifetime. The lifetime, for example, is determined by the interval between two subsequent measurements.

By means of wireless communication and by using well-known forwarding algorithms for multi-hop communication (for example geographic broadcasting), the information can be distributed in the geographic area to further nodes. In case that after the initial distribution, a new node connects to the network or enters the geographic area concerned, in case of known methods, this information is not transmitted to the new node, even though the information is possibly still valid, i.e. its lifetime has not expired yet. But some applications, such as, for example, the traffic safety applications for vehicles as mentioned above, require the reliable distribution of information over the time to all the nodes inside a geographic area.

Known methods fulfill this requirement by providing that the information is retransmitted at certain intervals. Such a re-transmission is problematic in the sense that it creates a high data volume and hence consumes many network resources. Furthermore, it is inefficient, because the information is re-transmitted to all of the nodes within a geographic area, independently from the fact whether a node has already received the information before. Hence, with the existing algorithms for information distribution in geographic areas, no reliable and efficient information distribution covering the whole lifetime of the information can be realized.

Algorithms that are typically used for information distribution within a geographic area work in such a way that nodes transmit a message to all the neighbor nodes and these nodes, in turn, re-broadcast this message. Such algorithms are called “flooding” or “broadcasting” algorithms. (See B. Williams and T. Camp, “Comparison of Broadcasting Techniques for Mobile Ad Hoc Networks”, Proceedings of the 3rd ACM international symposium on Mobile ad hoc networking & computing, pp. 194-205.) In the basic algorithm called “simple flooding”, each node rebroadcasts each message once. By doing so, the message is multiplied in the network and hence consumes a big part of the available wireless system (for example IEEE 802.11). More advanced broadcasting schemes select specific nodes in the target area for rebroadcasting (e.g., based on geographical positions or additional neighbors to be reached). These algorithms reduce the network load at the cost of reduced reliability in the distribution. However, all broadcasting techniques aim on the distribution of a message at a specific point of time and can not provide reliability over time. Furthermore, it can occur that several nodes detect a specific event simultaneously and distribute corresponding information. In such a case it can easily happen that the network is overloaded, which on the other side negatively impacts the reliability of the information distribution. In case of VANETs this applies in particular if the wireless channel is used—besides safety-related applications—for additional data traffic, as for example infotainment.

As an efficient broadcasting technique, a neighbor list is added to the broadcast (i.e. flooded) packet, in order to reduce the number of packet re-transmissions. (See H. Lim, C. Kim, “Multicast Tree Construction and Flooding in Wireless Ad Hoc Networks”, MSWIM, pp. 61-68, Boston, USA, 2000.) However, in case that a new node connects to the network or enters the geographic area concerned, this information is not transmitted to the new node, even though the information is possibly still valid, i.e. its lifetime has not expired yet.

Hence, the present invention is based on the task to specify a method of the above mentioned kind, with which an efficient and reliable information distribution can be achieved in a geographic area.

### SUMMARY OF THE INVENTION

The task mentioned above is solved by a method showing the characteristics of claim 1.

In case of the claimed method for information distribution to nodes of a mobile ad hoc network, the nodes dispose of means for position sensing and a pre-determinable geographic target area is defined and a pre-determinable lifetime is assigned to every piece of information. Moreover, during its lifetime, a piece of information is distributed to all the nodes that are positioned within the target area or entering the target area by adding geographical information about the target area and a list of single-hop neighbor nodes within the target area to the broadcast message with which a node transmits the information, and nodes that receive the message only re-transmit the message if they have further nodes in their neighborhood and inside the target area that are not included in the received list.

According to the invention, it has first been recognized that the efficiency as well as the reliability of information distribution in ad hoc mobile networks can be improved by reducing that amount of data that is transmitted and required for the information distribution. In order to reduce the transmitted amount of data, the method according to the invention combines a specific addressing scheme with a spatial and temporal component. The spatial and temporal components are basically characterized in that a geographic target area is defined and that every piece of information is assigned a pre-determinable lifetime. During its lifetime, a piece of information is distributed to all of the nodes positioned within the target area as well as to the nodes entering the target area during the lifetime of the said information. To localize the position of the nodes within the network, the nodes dispose of means for position sensing.

Regarding the addressing scheme, according to the invention, a node sending or forwarding a piece of information appends a list with its single-hop neighbor nodes within the target area to the broadcast message, in addition to the geographic coordinates of the target area.

Nodes receiving this message use the list to re-broadcast this message, only if nodes, that are not included in the received list, are positioned within their neighborhood and inside the target area.

Due to the method according to the invention, it is first of all guaranteed that all the nodes of the network receive as fast as possible all the information that is relevant due to the positioning of the nodes within the geographic target area. This includes in particular those nodes that connect to the network or enter the geographic target area after the distribution of this information, but before the expiration of the lifetime of the information. Furthermore, the efficiency of the information distribution is strongly improved, because unnecessary replication of data is avoided due to the distribution scheme according to the invention. In particular, if several nodes of the network detect an event almost simultaneously and distribute a corresponding piece of information once, an overload of the restricted wireless bandwidth can hence be avoided, which also increases scalability at the same time. Since overloading the network is avoided due to reducing the amount of data, the reliability of data distribution is increased because the probability of a loss of information is reduced.

It can be provided in an advantageous way that the geographic target area is defined individually on the base of a specific event detected by an originator node. By doing so, it can be taken into consideration that a specific event (for example, the detection of an end of a traffic jam) is only relevant for a specific geographic area. In case of a traffic jam, the geographically relevant area is, for example, restricted to the area that extends on the concerned side of the road behind the end of the traffic jam contrary to the driving direction.

Regarding a simple transmission, it can be provided that the defined geographic target area is transmitted in the header of the broadcast message.

Regarding the provision of information with respect to the physical position of individual nodes, any kind of position services can be used. Using GPS (Global Positioning System) is especially preferable. The exchange of information between neighbored nodes regarding their respective positioning can be performed by exchanging beacon messages.

In an advantageous way it is provided that each of the broadcast messages are single-hop broadcast messages, i.e. messages are only sent to the direct neighbor nodes.

Regarding an effective information management and a good compatibility, a uniform information structure storing the whole relevant data can be provided for all nodes. In this case, the information structure for every event can show, for example, an interlinked substructure specified for message, event, target area and distribution related information. (See FIG. 2)

Regarding the distributed information it is provided that it is stored during the whole of its lifetime by all the nodes to which it was distributed to. By these means, a distribution of the information during its lifetime to nodes entering the geographic target area afterwards becomes possible.

In a particularly preferred embodiment it is provided that the communication between the nodes is controlled by an entity for information management which will be referred to in the following as information management unit. The information management unit can be responsible, in particular, for sending and receiving of messages, for the control of timers and for the generation, the aggregation and the deletion of data elements of the information structure. Furthermore, the information management unit can provide an interface to the means for position sensing and/or other sensors, with which the nodes are equipped for sensing data.

As soon as a node receives a message, it is provided that it checks its local information structure whether the information contained in the message is already registered. If this is not the case, the node will integrate the information into its locally stored information structure. In addition, it will start a timer for the lifetime of the information. Furthermore, it can be provided that the node adds the sending node of the message to an acknowledgement list and marks it as informed. Subsequently, the node will send a broadcast message on its part in order to distribute the information within the geographic target area. In this case it can be provided that—in addition to its own neighbor nodes within the target area on the list appended to the broadcast message—the node adds the neighbor nodes of the sending node that are within the target area.

By these means, the size of the message may increase, but at the same time a redundant exchange of messages between the nodes already informed can be avoided, if the nodes move within the target area.

Regarding a particularly high level of reliability with respect to the information distribution, an—active or passive—acknowledgement of sent messages can be provided. The preferred passive acknowledgement means that a sending node (which precedes in the distribution chain) “overhears” the forwarding of the information of a forwarding node to a succeeding node. In wireless environments with a shared medium, this can be achieved by sending a message over the same wireless channel as the original message. The sending node interprets in this case the “overheard” message as passive acknowledgement. An active (i.e.,explicit) acknowledgement message can only be provided for cases where the information is not required to be forwarded, for example, because the forwarding node does not have any further neighbors.

In the context of an active acknowledgement it can be provided that a node—in case it receives an active acknowledgement message—adds the sender of the acknowledgment to the acknowledgement list of the sender of the information and marks it as informed. When the sender receives the acknowledgments of all nodes, it cancels the corresponding timer.

In order to prevent information loss, a message, that is not (i.e. neither in an active nor in a passive way) acknowledged, can be re-transmitted in an advantageous way, after a period of time, that can be pre-determined by a timer, has elapsed. The period can be adjusted to the concrete application, wherein, for example, the importance of the information to be distributed and/or the lifetime of the information can be aspects to be considered. In a preferred embodiment, the number of sending trials is limited by a counter.

Regarding a smooth temporal order of the individual process steps, time synchronization between the nodes proves to be advantageous. The time synchronization can either be realized as relative or absolute time synchronization.

After expiration of the lifetime of the information, the information as well as its corresponding acknowledgement lists and all of the timers can be erased. By these means storage of unnecessary data is avoided and, over all, the required storage capacity can be kept relatively small.

Now, there are several options of how to design and to further develop the teaching of the present invention in an advantageous way. For this purpose, it must be referred to the claims subordinate to claim 1 on the one hand and to the following explanation of a preferred example of an embodiment of the invention together with the figure on the other hand. In connection with the explanation of the preferred example of an embodiment and the figure, generally preferred designs and further developments of the teaching will also be explained.

### BRIEF DESCRIPTION OF THE DRAWINGS

FIG. 1 is a schematic diagram showing an example of an embodiment of the method according to the invention;

FIG. 2 is a schematic diagram showing an information structure as used in the example as given in FIG. 1; and

FIG. 3 is a block diagram showing an information management unit as used in the example as shown in FIG. 1.

### DETAILED DESCRIPTION OF THE PREFERRED EMBODIMENTS

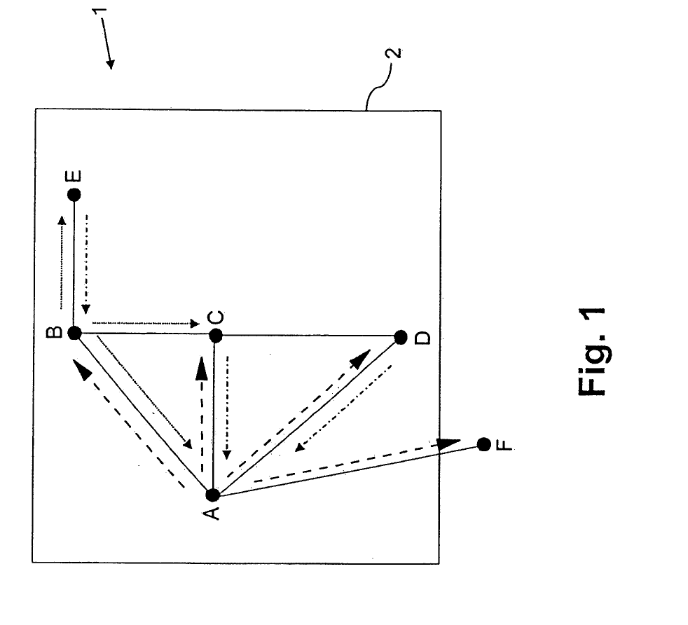

FIG. 1 depicts schematically the functioning of the method according to the invention to distribute information of nodes of a mobile ad-hoc network 1. In FIG. 1, there are all in all six nodes (A, B, C, D, E and F) of the network 1 depicted. Node A is the originator node that has detected a specific event (as, for example, an icy road). On the base of this event, a geographic target area 2 is defined. The nodes A to E are within, node F is outside the geographic target area 2.

The continuous connecting lines between the individual nodes A to F mark single-hop connectivity on the base of the wireless transmission range. Node A distributes information corresponding to the detected event by sending a geo-broadcast message (dashed line) to the neighbored nodes B, C and D. Among other things, the message comprises a list in which the identifiers of the neighbored nodes within the target area 2, i.e. the nodes B, C and D, are listed.

Node F, which receives the message due to the broadcast characteristic, ignores the message, because it is located outside the geographic target area 2 and is not addressed by the list in the packet.

The rest of the nodes B, C and D check their local information structure on whether they have already been informed about the event and hence have stored the corresponding information. If this is not the case, they store the information and start a timer for the lifetime of the information. Furthermore, the nodes B, C and D add each the identifier of node A and the identifiers of the listed nodes (except for their own identifier) to their acknowledgement list and mark them as informed.

In a next step each of the nodes B, C and D compare the list of the identifiers of the nodes which are neighbored and located within the geographic target area 2 to the list of the node identifiers contained in the message received from node A. By this comparison, both nodes C and D find that no neighbored nodes exist which were not covered by the message sent by node A. Consequently, the nodes C and D send back an active acknowledgement message (line consisting of dots and dashes) to the originator node A. This acknowledgement message informs the originator node A that its message was received correctly. Then, node A marks the corresponding entry or the corresponding entries in the acknowledgement list as informed and resets the corresponding timer regarding a re-transmission of the information.

In contrast, when comparing, node B finds that a node—node E—exists which was not contained in the message sent by originator node A. Hence, node B generates a new message (dotted lines). Here, node B writes the identifiers of its neighbored nodes—node A, C and E—in the header of the new message. Alternatively, node B can add to the header a cumulated identifier list of its neighbored nodes and those nodes that are neighbors to the preceding nodes in the distribution chain, i.e. node A. The message generated by node B is interpreted by the preceding node, i.e. node A, as passive acknowledgement message. Hence, node A marks in its acknowledgement list node B as informed and resets the corresponding timer for a new re-transmission.

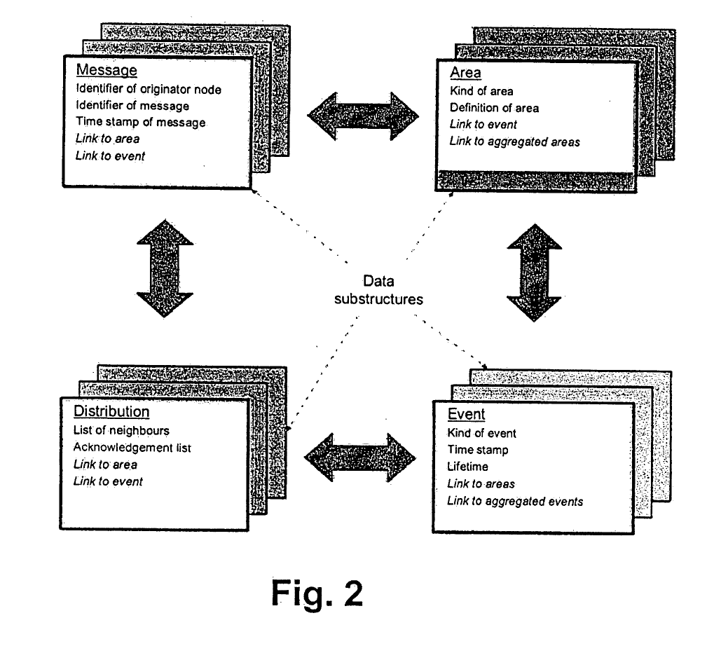

FIG. 2 shows schematically the information structure with which relevant data of the nodes is stored and which is designed in a uniform way for all nodes. The information structure divides into four data sub-structures, i.e. in concrete a message-related, an area-related, a distribution-related and an event-related sub-structure. The individual data of the sub-structures are interlinked by corresponding references. The message-specific sub-structure comprises, for example, the identifier of an originator node, a message identifier, as well as a link to the corresponding geographic target area and the corresponding specific event detected by the originator node.

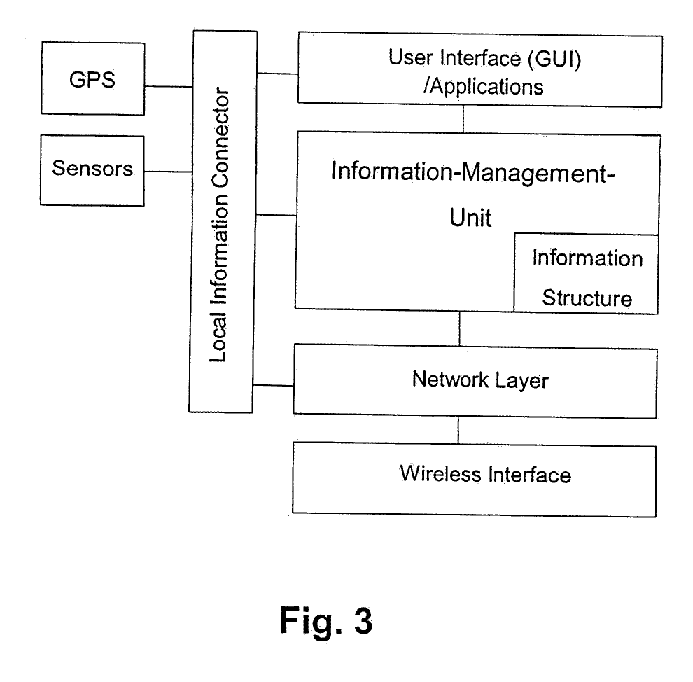

FIG. 3 shows in a scheme the composition of an information management unit. The information management unit controls the whole communication and it is, in particular, responsible for sending and receiving messages, for controlling timers as well as for generating, aggregating and erasing data elements of the information structure. For this purpose, the information management unit provides for a connection to the user interface and the several applications on the one hand, and it also acts as a connection to the wireless interface over the network layer on the other hand. Furthermore, the information management unit provides for a connector to the required local information, wherein the local information is achieved, for example, by GPS and by other sensors.

Finally, it is particularly important to point out that the example of an embodiment described above only serves as illustration of the claimed teaching, but that it does by no means restrict the latter to the given example of an embodiment.

1. A method for distributing information to nodes of a mobile ad hoc network, wherein the nodes dispose of means for position sensing, wherein a pre-determinable geographic target area is defined and every information is assigned a pre-determinable lifetime, and wherein an information is distributed during its lifetime to all of the nodes being positioned within the target area and to the nodes entering the target area by adding a list of correspondingly neighbored nodes in the target area to a broadcast message by which a node sends the information, and nodes, which receive the message, only re-transmit the message if they have at least one further neighbored node in the target area that are not contained in the received list.

2. The method according to claim 1, wherein the geographic target area is defined on the base of a specific event detected by an originator node.

3. The method according to claim 1, wherein the defined geographic target area is transmitted in the header of the broadcast messages.

4. The method according to claim 1, wherein position sensing of the nodes is performed by a position service, preferably GPS (Global Positioning System).

5. The method according to claim 1, wherein neighbored nodes inform each other about their current positions by exchanging beacon messages.

6. The method according to claim 1, wherein the broadcast messages are single-hop broadcast messages.

7. The method according to claim 1, wherein the information is stored by the nodes with a uniform information structure.

8. The method according to claim 7, wherein the information structure shows a substructure specified for messages, target area, distribution and events.

9. The method according to claim 1, wherein the information is stored during its lifetime by the nodes in the target area.

10. The method according to claim 1, wherein the communication between the nodes is controlled by an information management unit.

11. The method according to claim 10, wherein the information management unit provides for a connector to the means of position sensing and/or other sensors.

12. The method according to claim 7, wherein a node checks its local information structure upon receipt of a message regarding the fact whether the information contained in the message is already registered.

13. The method according to claim 12, wherein the node—if it is located within the target area—integrates the information (if not already registered) into its locally stored information structure and starts a timer for the lifetime of the information.

14. The method according to claim 12, wherein a receiving node—if it is located within the target area—adds the sending node of the message to its acknowledgement list and marks the sending node as informed.

15. The method according to claim 14, characterized in that the receiving node—if it is located within the target area—adds the list of nodes contained in the received message to its acknowledgment list and marks these nodes as informed.

16. The method according to claim 1, wherein to the list of neighbors appended to the broadcast message, with which a forwarding node forwards the information, adds the single-hop neighbored nodes of the sending node that are located within the target area, in addition to the single-hop neighbored nodes of the forwarding node, that are located within the target area.

17. The method according to claim 1, wherein the sent messages are acknowledged either in an active or a passive way.

18. The method according to claim 17, wherein a node adds the sending node to its acknowledgement list after receipt of an active acknowledgement message, marks the sending node as informed and re-sets the corresponding timer.

19. The method according to claim 16, wherein a message, that has not been acknowledged, is re-transmitted after a pre-determinable period of time, measured by a timer.

20. The method according to claim 19, wherein the number of sending trials is limited by a counter.

21. The method according to claim 1, wherein time synchronization is performed between the nodes.

22. The method according to claim 1, wherein the information, the corresponding acknowledgement list, as well as all of the timers are erased after expiration of the lifetime of the information.

23. The method according to claim 7, wherein the information, the corresponding acknowledgement list, as well as all of the timers are erased after expiration of the lifetime of the information.

24. The method according to claim 8, wherein the information, the corresponding acknowledgement list, as well as all of the timers are erased after expiration of the lifetime of the information.

25. The method according to claim 9, wherein the information, the corresponding acknowledgement list, as well as all of the timers are erased after expiration of the lifetime of the information.

26. The method according to claim 21, wherein the information, the corresponding acknowledgement list, as well as all of the timers are erased after expiration of the lifetime of the information.

27. A system for distributing information to nodes of a mobile ad hoc network, wherein each of the nodes comprises:
a position sensor;
a wireless transceiver; and
an information manager for controlling such that a pre-determinable geographic target area is defined and every information is assigned a pre-determinable lifetime, and wherein the information is distributed during its lifetime to all of the nodes being positioned within the target area and to the nodes entering the target area by adding a list of correspondingly neighbored nodes in the target area to the broadcast message by which a node sends the information, and wherein when having received a broadcast message, the broadcast message is only re-transmitted if it has at least one further neighbored node in the target area that are not contained in the received list.

28. A node in the system according to claim 27.
